(19) United States
(12) Patent Application Publication
(10) Pub. No.: US 2007/0176418 A1
(43) Pub. Date: Aug. 2, 2007

(54) Electrically heatable coupling and an encased fluid hose with an electrically heatable coupling

(75) Inventors: Lars Frogneborn, Goteborg (SE); Bengt Henstrom, Alingsas (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/570,504

(22) PCT Filed: Jun. 15, 2005
(86) PCT No.: PCT/SE05/00934

§ 371 Date: Dec. 13, 2006

(30) Foreign Application Priority Data
Jun. 15, 2004 (SE) 0401557-4

(51) Int. Cl. F16L 33/00

(52) U.S. Cl. 285/242

(57) ABSTRACT

The invention relates to a coupling (5) for fluid, comprising a first connecting section (20) for connection to a fluid hose (2) and a second connecting section (21) for connection to an opposing coupling (14), in which the coupling (5) also comprises a heating section (22) intended for a heating means (23). The object of the invention is to provide a heated coupling for use together with an electrically heated, encased fluid hose. The invention also relates to an encased fluid hose (1) connected to a coupling (5) comprising a heating section (22).

### BACKGROUND AND SUMMARY

The present invention relates to an electrically heatable coupling and an encased fluid hose with an electrically heatable coupling, preferably intended for use in vehicles.

In vehicles, there are reservoirs for fluids which are used for various functions of the vehicle. In certain cases there is a need to ensure that these fluids have a certain temperature to enable them to function as intended. In other cases, it is merely important to ensure that the fluids do not freeze. In these cases, a fluid tank, for example, can be provided with a heating device for thawing the fluid once it has frozen. When the vehicle is started, then the fluid is thawed with the heating device. For a satisfactory functioning of the fluid system, the fluid in the hose leading from the fluid tank should also be thawed. This calls for the hose, too, to be provided with a heating device for thawing fluid which has frozen in the hose.

The present invention can be applied in respect of heated hoses, not just for vehicle applications, but the description below will specifically set out, for illustrative yet non-limiting effect, how the invention can be applied in a heated hose conducting urea, also referred to as AdBlue, which is used for cleaning exhaust gases originating from an internal combustion engine. An existing problem in the use of urea is, however, that urea, in cold weather, can freeze in the container and/or in associated hoses. If the urea freezes, it can mean, in turn, that urea cannot be supplied as intended. There is therefore a need to be able to warm the urea-transporting hoses.

There are various ways of warming the fluid in a hose. One way is to warm the hose with cooling water. This means, on the one hand, that the heating is delayed until the engine has warmed up and, on the other hand, that a number of extra hoses, couplings, etc. are called for, which becomes expensive and complicated. A simpler way is to warm the hose with electricity.

There are also vehicles designed to transport dangerous goods, in which special safety requirements apply. On the one hand, there are national safety requirements drawn up by each individual country, on the other hand there are international agreements which regulate safety requirements on an international level. Such an international agreement is “The European Agreement concerning the International Carriage of Dangerous Goods by Road (ADR)”, agreed in Geneva on 30 Sep. 1957 under the auspices of UNECE. This agreement has subsequently been updated. This agreement governs how dangerous goods shall be transported by trucks on roads. One of the requirements is that the supply voltage of the vehicle shall be able to be cut off during travel, for example when the driver activates an emergency switch in the cab, when the system detects a safety-related occurrence, or when an accident occurs. In addition, the electric cabling must be encased. For certain vehicles, it is also required that the electric cabling shall satisfy protection class IP69K. One of the requirements for this protection class is that all electric cabling is fully encased. This encasement can be realized, for example, with corrugated plastic hose.

Usually, those vehicles which are to be ADR classified have to be specially ordered with special equipment ensuring that the vehicle meets the stipulated requirements. To avoid having to convert the whole vehicle when an ADR classified vehicle is to be produced, it is advantageous that as much as possible of the vehicle's standard equipment conforms to the ADR classification. This reduces the number of article numbers, which simplifies the production. Since an ADR classified component is often more robust than a standard component, this is also advantageous for the quality of the vehicle.

In order to enable a rational production, it is advantageous for the fluid hose to be provided with couplings, so that a plurality of sub-systems of, for example, fluid hoses can be coupled together to form a complete unit. When an ADR classified vehicle is provided with a fluid hose which is electrically heated, couplings are required both for the hose and for the electrical connection. At the same time, all electric cabling must be fully encased, so that no cable part is unprotected.

There are many known proposals on how a heated fluid hose can be obtained. WO 200238426A, EP 45024 A and DE 29715336 describe systems in which a heating cable lies inside the fluid hose. One drawback is that such a solution can cause leakage at the coupling points where the cable is introduced into the hose. Nor is it desirable to run a cable in urea. Moreover, this solution is unsuitable for fluid hoses with couplings.

U.S. Pat. No. 5,791,377A, EP 616166A, EP 1040973A and DE 19844486A describe fluid hoses in which the heating cable is integrated in the hose casing and in which the wires are provided with some form of special connector for switching on of the electric current, in which the connector, too, is fixed in the hose. The drawback with these solutions is that they require a special electrical connector. The provision of like systems for a specific vehicle, for example a truck, therefore requires that a specific connector is produced. This is an expensive solution. Nor is such a solution particularly robust, since a large connector fixed in a narrow hose provides a mechanically disadvantageous solution.

DE 3900821C, EP 1329660A, DE 19844485A, DE 3900821C describe fluid hoses in which the heating cable is integrated in the hose casing. The connection of the heating cable must be realized conventionally, which means that the heating cable is unprotected as it emerges from the hose.

Common to the abovementioned, known heatable fluid hoses is the fact that only the fluid hose is heated. This can create problems where couplings are used, for example when the fluid has frozen in the hose and the fluid has to be rethawed. When the fluid hoses are heated, it can happen that the fluid in the couplings does not thaw, especially if it is cold and the couplings are left unprotected.

It is therefore desirable to provide an electrically heatable coupling, expediently for use together with a heated, encased fluid hose.

With a coupling for fluid, comprising a first connecting section for connection to a fluid hose and a second connecting section for connection to an opposing coupling, according to an aspect of the present invention, the coupling comprises a heating section intended for a heating means. This first aspect of the coupling according to the invention produces a heatable coupling intended for connection to a fluid hose which is warmed with an electric cable and which is fully encased in a protective sheath. The purpose of this is to obtain a coupling which can prevent lumps of ice, for example, which can be formed at the coupling points on the heated cabling.

In an advantageous first refinement of the coupling according to an aspect of the invention, the heating section is intended to be entwined with a predefined number of turns of a heating cable. An advantage with this is that the same heating cable can be used to heat the fluid hose and the coupling.

In an advantageous second refinement of the coupling according to an aspect of the invention, the coupling comprises a sealing flange for connection to a connecting piece. An advantage with this is that the sealing flange seals against the connecting piece without the need for expensive special components.

In an advantageous third refinement of the coupling according to an aspect of the invention, the coupling comprises a dividing Flange, which demarcates the first connecting section and the heating section. An advantage with this is that the fluid hose can be positioned in a predetermined manner and that the number of turns of the heating cable around the heating section can be predetermined with the aid of the length of the heating section.

In an advantageous fourth refinement of the coupling according to an aspect of the invention, the coupling is made of a metal material. An advantage with this is that the metal has good heat conduction and that a good corrosion resistance can be obtained. In an advantageous fifth refinement of the coupling according to the invention, the coupling is of the male type. The advantage with this is that the coupling sticks into the opposing coupling, which increases the heat delivery to the opposing coupling.

The inventive encased fluid hose for a motor vehicle comprises a fluid hose, a heating cable for heating the fluid hose, at least one electrical connector for connecting the heating cable up to an electrical supply, at least one coupling for connecting the fluid hose up to an opposing coupling, in which the fluid hose and the heating cable are enclosed by an outer protective sheath, and in which the coupling comprises a heating section intended to support a heating means. An advantage with this encased fluid hose is that a heated fluid hose is obtained, in which the content of the entire hose and of couplings belonging thereto can be warmed, so that lumps of ice can be avoided.

### BRIEF DESCRIPTION OF THE FIGURES

The invention will be described in greater detail below with reference to illustrative embodiments shown in the appended drawing, in which:

FIG. 1 shows an encased fluid hose with a heated coupling according to the invention in cross section, and

FIG. 2 shows a coupling according to the invention.

### DETAILED DESCRIPTION

The following described illustrative embodiments of the invention with refinements should be regarded only as examples and should in no way limit the scope of protection of the patent claims. In the illustrative embodiments which are here described, the same reference numerals refer in the different figures to the same type of component. Not every component is therefore described in detail in illustrative embodiments.

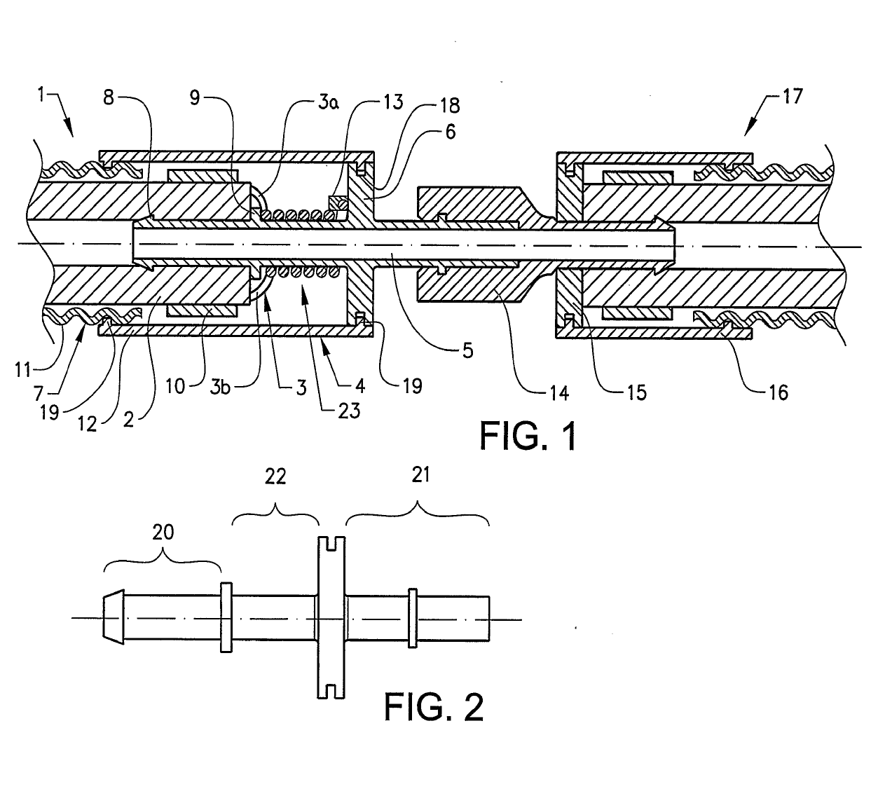

FIG. 1 shows a section of a heatable, encased fluid hose 1 with a coupling 5 according to the invention in cross section. The encased fluid hose 1 comprises a fluid hose 2, made of rubber, for example, with integrated heating cable 3 for heating of the hose 2. The hose 2 and the heating cable 3 are enclosed in a protective sheath 7. In this example, the heating cable 3 consists of two wires 3a, 3b, which are cast into the casing of the hose 2. The wires 3a and 3b are realized with a predefined resistivity, so that a defined heat generation is obtained when the wires are connected to a current source. In the shown end section 4 of the encased fluid hose, the heating cable 3 is freed from the hose 2. It is also possible, of course, to use a separate heating cable, which is fixed to the outer side of the hose or which lies loose in the protective sheath 7.

The protective sheath 7 of the encased fluid hose is here made up of a system of corrugated plastic hoses and connecting pieces belonging thereto. The encased fluid hose shown in FIG. 1 comprises, in this case, a corrugated hose 11 having an inner cross section which exceeds the outer cross section of the fluid hose 2. The encased fluid hose further comprises connecting pieces on the end sections of the fluid hose, of which a connecting piece 12 is shown here. An opposing, encased fluid hose 17 comprises an opposing coupling, here a coupling 14 adapted for connection to a coupling 5, as well as a connecting piece 16 and a sealing element 15. The sealing element 15 can be a standardized bushing element in the form of a rubber bushing or diaphragm bushing, for example of the type which is used as a cable duct in electrical apparatus. This means that the whole of the encased fluid hose is made up of standard components, which makes the finished encased fluid hose easy and cheap to assemble. It is also possible for the sealing element 15 to be specially produced when a standardized sealing element is unsuitable.

The purpose of the coupling 5 is to enable a heating of that part of the encased fluid hose which is not provided with heating in the form of a heating cable. Since all electrical wires have to be encased, the heating cable cannot easily be led over through the coupling. Since the standardized couplings which are normally used are made of plastic, they do not conduct heat particularly well. The result is that an encased fluid hose with standardized couplings is unable to thaw lumps of ice formed in the couplings, even when the encased fluid hose is heated.

The coupling 5 is therefore made of a metal material, advantageously of a material tailored to the fluid which is used. For urea, a stainless steel material, for example, is expedient. It is also conceivable to use a composite material with good thermal conductivity. Expediently, a material is used having a thermal conductivity exceeding 10 W/(m*K) and advantageously in the region around or above 40 W/(m*K), in which, for example, stainless steel is found. Advantageously, the coupling is rotationally symmetrical. This shape allows rational, high-precision production.

FIG. 2 shows the coupling 5 with a first connecting section 20, a second connecting section 21 and a heating section 22. The first connecting section 20 is intended for connection to a fluid hose 2 and is therefore provided with a conical engagement part 8, which secures the coupling 5 in the fluid hose 2. The coupling 5 is fixed to the hose with the aid of a clamping ring 10. The first connecting section 20 is demarcated with a dividing flange 9, the purpose of which is to give the fluid hose a definite position on the coupling. Together with the clamping ring 10, a secure and robust connection between the coupling 5 and the fluid hose 2 is then obtained.

The second connecting section 21 is intended for coupling with an opposing coupling. This can be, for example, a hose-mounted coupling, such as, for example, the illustrated coupling 14, or couplings mounted on other units, such as a pump, a spreader or a tank.

The heating section 22 is intended for a heating means 23. The heating means can be a separate heating unit or it can consist, as in this illustrative embodiment, of a number of wound turns with the heating cable 3. The heating section is demarcated by the dividing flange 9 and the sealing flange 6. The length of the heating section is expediently adapted such that a predetermined number of turns of the heating cable are accommodated around the heating section. In this way, the desired heating effect can be easily chosen, which also simplifies the production of finished units with encased fluid hoses. In the heating section, the wires 3a and/or 3b are wound with a chosen number of turns such that the desired heating effect is obtained. The heat which is generated in this region is dimensioned such that it is sufficient to heat up the whole of the coupling and hence transmit the heating effect to a possible lump of ice. In the end section 4 of the encased fluid hose, the heating cable 3 is set free from the hose 2 such that the wires 3a and 3b can be wound around the coupling 5. The wires 3a and 3b are coupled together with an electric clamp coupling 13 such that a closed electric circuit is created. The clamp coupling 13, like the wires 3a and 3b, is electrically insulated from the coupling. The electrical insulation of the coupling prevents creeping currents, which is advantageous from the safety aspect and makes the coupling easier to handle. In this illustrative embodiment, the coupling 5 is of the male type. This means that the coupling will stick into the opposing coupling so that broadly the whole of the coupling will be heated. The result is that broadly the whole of the uninsulated part of the encased fluid hose will be heated. There is thus no need for a separate, external heating of the coupling and/or a separate insulation of the coupling. In order to improve the heat transmission, it may be advantageous for the opposing coupling, too, to be made of a material having good thermal conductivity, for example a metal.

An opening in a connecting piece is provided with an inner, protruding cam 19 close to the opening. This cam is for fixing the corrugated hose to the connecting piece. A connecting piece consists of two part-halves, which are snap-fitted together in assembly. This means that the cams in each part-half together fix the corrugated hose in the longitudinal direction, since the cams interact with a valley in the corrugated hose. The sealing flange 6 in the coupling 5 is therefore advantageously provided with a groove 18, which fits against the cam 19 of the connecting piece in order thereby to fix the coupling in the connecting piece.

In the embodiment of a heated coupling which is shown here, the coupling is of the male type. It is also possible, of course, to provide a female-type coupling with heating in the same way.

The invention should not be considered to be limited to the illustrative embodiments described above, but rather a host of further variants and modifications are conceivable within the scope of the following patent claims. The coupling can be used, for example, not only for vehicles, but also in other applications in which a heated coupling of hoses is required.

### FIGURE REFERENCES

1 encased fluid hose
2 fluid hose
3 heating cable
3a wire
3b wire
4 end section
5 coupling, male
6 flange
7 protective sheath
8 engagement
9 dividing flange
10 clamping ring
11 corrugated hose
12 connecting piece
13 electric clamp coupling
14 coupling, female
15 sealing element
16 connecting piece
17 opposing, encased fluid hose
18′ groove
19 cam
20 first connecting section
21 second connecting section
22 heating section
23 heating means

1. A coupling for fluid, comprising a first connecting section for connection to a fluid hose and a second connecting section for connection to an opposing coupling, wherein the coupling comprises a heating section intended to be entwined by a predefined number of turns with a heating cable so that the heating cable is electrically insulated from the coupling.

2. The coupling as claimed in claim 1, wherein the heating section is disposed between the first connecting section and the second connecting section.

3. The coupling as claimed in claim 1, wherein the coupling is part of an encased fluid hose.

4. The coupling as claimed in claim 3, wherein the heating section is disposed between the first connecting section and the second connecting section.

5. The coupling as claimed in any claim 1, wherein the coupling is rotationally symmetrical around its center axis.

6. The coupling as claimed in claim 1, wherein the coupling comprises a sealing flange connectable to a connecting piece.

7. The coupling as claimed in claim 6, wherein the sealing flange is provided with a groove for interaction with a cam in the connecting piece.

8. The coupling as claimed in claim 1, wherein the coupling comprises a dividing flange which demarcates the first connecting section and the heating section.

9. The coupling as claimed in claim 1, wherein the coupling is made of a material having a thermal conductivity exceeding 10 W/(m*K).

10. The coupling as claimed in claim 1, wherein the coupling is made of a metal material.

11. The coupling as claimed in claim 1, wherein the coupling is of the male type.

12. An encased fluid hose for a motor vehicle, comprising a fluid hose, a heating cable for heating the fluid hose, at least one electrical connector for connecting the heating cable up to an electrical supply, at least one coupling for connecting the fluid hose up to an opposing coupling, in which the fluid hose and the heating cable are enclosed by an outer protective sheath, wherein the coupling comprises a heating section intended to support a heating means.

13. The encased fluid hose as claimed in claim 12, wherein the heating means is comprises a plurality of wound turns with the heating cable.
